(19) United States
(12) Patent Application Publication
(10) Pub. No.: US 2011/0266092 A1
(43) Pub. Date: Nov. 3, 2011

(54) Checkstand and Method

(75) Inventors: Craig Marquis, (US); Jaren Shaw, (US); Joe Villareal, (US); Dianah Apaez Rojas, (US); Jimmy Jiminez, (US); Tammy Hager, (US); Arthur Scruggs, (US); Lori Ihle, (US)

(73) Assignee: HEB Grocery Company, LP.

(21) Appl. No.: 12/771,941

(22) Filed: Apr. 30, 2010

(51) Int. Cl. A47F 9/04; G07F 7/04; G06K 5/00; G07F 1/00

(52) U.S. Cl. 186/61; 194/353; 194/206; 186/66; 235/380

(57) ABSTRACT

A checkstand for a retail store provides systems and methods for point of sale transactions in which a cashier scans items and places the scanned items directly into bags contained on a rotating carousel with multiple bag racks spaced around the carousel, and a deck above the carousel for holding items too large or bulky to be placed in bags. The systems and methods further provide a self service payment station.

### SUMMARY

A checkstand for a retail store provides systems and methods for point of sale transactions in which a cashier scans items and places the scanned items directly into bags contained on a rotating carousel with multiple bag racks spaced around a central column of the carousel, and a deck above the carousel for holding items too large or bulky to be placed in bags. The systems and methods can further provide a self service payment station. The disclosed systems and methods provide advantages and efficiencies over prior systems in which a checker or cashier scans all items, collects payment and then bags the items. The methods also provide advantages over self service checkout systems in which customers scan their own items and then utilize self service payment. Such systems are typically limited to a low number of items, such as 20 or less. The disclosed systems and methods can be used without limiting the number of items and without the need for additional security measures that are needed with complete self service systems.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” or “the” may mean a singular object or element, or it may mean a plurality, or one or more of such objects or elements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a perspective view of an embodiment a checkstand.

FIG. 2 is an alternate view of an embodiment of a checkstand.

FIG. 3 is an alternate view of an embodiment of a checkstand.

FIG. 4 is a view of a base of a checkstand carousel.

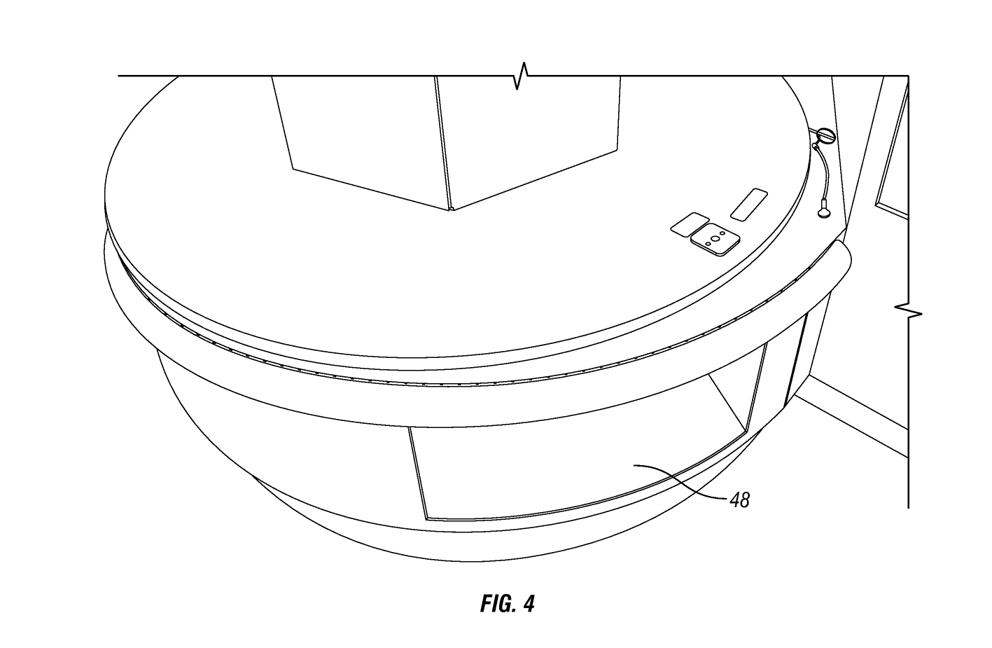

### DETAILED DESCRIPTION

The present disclosure can be described in certain embodiments as a checkstand for use in a retail store. A checkstand is a structure that provides a location and equipment for a point of sale transaction, typically when a customer brings one or more items to a cashier to complete the purchase. As shown and described herein a checkstand can be an elongated structure in which a customer brings items to be purchased and places the items on a conveyor that transports the items to the cashier station. The items are scanned or entered into a point of sale device or system that totals the prices, records the payment, and provides a receipt of the transaction. After scanning, the items are passed to a receiving area on the opposite end of the checkstand from the conveyor, so the items pass from the conveyor across the scanner and into a bagging area. The checkstands are two sided along the long axis and can include a first side that is next to an aisle that can provide space for a customer to unload a basket of items onto a conveyor, termed the customer side herein, and an opposite side that includes a cashier station where the cashier stands or sits to remove the items from the conveyor, scan the items and move them to a bagging area, or to place them directly in bags held on bag racks or holders in the bagging area. The disclosed checkstands can be used in a retail grocery store, for example or in stores that sell hardware, general merchandise, or any items that can be scanned by hand and placed into bags.

The present disclosure includes a conveyor providing a surface for loading of items accessible from the customer side of the checkstand; a scanner adjacent the cashier station and disposed at an end of the conveyor; a carousel bagging device adjacent the scanner and comprising a plurality of bag holders spaced around a turnable central column and a horizontal, planar surface above the carousel and sized to support items too large to fit in conventional bags; and a pay station on the customer side of the checkstand opposite the cashier station.

The customer pay station can include necessary structures to accept any type of self service payment accepted by the store, including but not limited to cash and credit/debit card payments. Such devices can include credit or debit card readers that are well known in the art and read a magnetic stripe on the credit card. Such readers can provide a slot for a customer to swipe a card and charge the transaction to the card account, or they can operate by wireless recognition of the credit or debit card. The pay station can also include a keypad, including electronic or physical keys, for entry of a personal identification number (PIN), zip code or other information, and can also provide a screen for accepting an actual customer signature. The pay station can also accept cash payments by use of a self service cash payment machine, including at least a coin receiving apparatus and a bill or note receiving apparatus as are also known in the art. In certain embodiments, the pay station can also include an automated teller machine function to provide cash to customers with a debit or credit card.

The scanner and pay station structures can be electronically connected to a point of sale terminal that records the transactions and causes printing of a receipt. The system can further include a monitor visible to the checker and/or to the customer. In certain embodiments, the point of sale terminal is in electronic communication with a point of sale server that saves all transactions to a database and that can be connected to additional servers.

The current disclosure thus provides advantages over previous self service checkout systems and methods for retail stores in that such systems have eliminated the need for a cashier to receive the payment, but rely on customer honesty to scan all items. Complicated and expensive systems that rely on measuring the weight of items, optical scanning of shopping baskets, and even RFID chips or other electronic tags in all items for sale have been described to prevent the fraudulent taking items that are not scanned. With the present disclosure, no such systems are necessary because the cashier scans and bags all the items while the customer utilizes the self service payment devices. The disclosed system, therefore, achieves a faster checkout provided by self service payment without the added risks of fraud or theft.

The disclosed systems and methods can also include a lockable drawer or cabinet attached to or adjacent the cashier station for restricted items. Restricted items can include cigarettes or tobacco products for example, that are not available to all customers and are not freely accessible. The disclosed systems provide a close, secure and convenient location for such items so the cashier does not have to stop and go to another location to retrieve such items, to rely on someone else to retrieve them, or to have them in an obstructive, overhead bin.

As described above, the disclosed checkstands can include a carousel bagging device adjacent the scanner and comprising a plurality of bag holders or racks spaced around a turnable central column and a horizontal, planar surface or deck at least partially above the carousel and sized to support items too large to fit in conventional bags. Bag holders can be any type of holder or rack known in the art, and can include, for example, a pair of arms, hooks or extensions spaced apart to hold the respective handle loops of a bag, or of a stack of bags. Because of the carousel arrangement, a checker or cashier can fill a bag or partially fill a bag and then turn the carousel to reach the next bag. In certain embodiments the carousel is turned manually, however, carousels that are turned by a motor are also contemplated. The customer can then take bags off the carousel from the customer side by rotating the carousel. As described herein, the bagging area or station also includes a planar horizontal structure or deck at least partially above the bagging carousel. In certain embodiments, this planar member is an extension of the top of the checkstand and is at level height with the scanner. In this way, the cashier can slide large or bulky items straight across onto this deck while bagging smaller items in a carousel at a lower level. The customer can then take the large or bulky items directly from the deck of the bagging area.

In certain embodiments such as those shown in the figures, the checkstands can include six spaced bag holders or racks. In such an arrangement, the central column of the carousel can be in a twelve sided or dodecagon shape and every other face would include a bag holder or rack. The bag holders would then be evenly spaced around the carousel. Other configurations with more or fewer bag holders can also be used in the practice of the disclosed systems and methods. The disclosure can thus accommodate checkstands for use in larger or smaller stores, or for different sized checkstands in a single store.

The disclosure can also be described in certain aspects as a checkstand for a retail checkout including a bagging station, where the bagging station includes a stationary cylindrically shaped base; and a carousel attached on top of the base by a central axis, the carousel including a rotatable platform and a central rotatable column where a plurality of bag holders are attached to and spaced around the central column; and wherein the checkstand further includes a planar surface located at least partially above the carousel and sized to hold items too large for conventional bags.

The checkstand as described can include any practical number of bag holders or racks. In certain preferred embodiments, the shape of the central column is a regular polygon shape with an even number of sides, such as a dodecagon, a decagon, an octagon, a hexagon or even a square. The central column can also be in a circular shape, and the shape and size determine the number of bag holders that can be spaced around the column, so the groceries can be bagged and adjacent bags do not interfere with each other. The central column can then have attached to it, any number of bag holders or racks including, but not limited to 6, 5, 4, 3, or 2 spaced apart bag racks. In certain embodiments the bag racks are evenly spaced around the carousel, but the spacing can change to meet the needs of a particular retail location.

The bagging stations of the disclosure thus provide certain advantages over prior bagging areas in which scanned items are pushed onto a deck or shelf with one or two stationary bag racks. In these types of checkstands, a cashier typically bags the items after everything has been scanned, or alternatively another employee must be provided to bag items while the cashier scans and moves items into a bagging area. It is thus an aspect of the disclosure that the checkstand and bagging carousel can also be utilized to increase efficiency and speed of checkout transactions in those embodiments in which there is no self service pay station.

It is a further aspect of the disclosure that in the described checkstands, a shelf or storage area can be provided in the base, below the level of the carousel. This can be an inset compartment type of storage for bags or other supplies to be used in the bagging station.

The present disclosure can also be described in certain embodiments as an improved method of retail checkout. The method includes providing a checkstand with an area for loading items to be purchased onto a surface that is accessible by a checker or cashier, providing a scanner adjacent the loading surface for the checker to scan the items to be purchased and providing a bagging station adjacent the scanner so the scanned objects can be placed directly into bags by the checker or the person who scans them. The method further includes providing a self service pay station for the customer that is not part of the cashier or checker station, but that is located on the checkstand on the opposite side from the cashier station. The method further includes providing a carousel bagging device or station adjacent the scanner and comprising a plurality of bag holders spaced around a turnable central column and a horizontal, planar surface above the carousel and sized to support items too large to fit in conventional bags.

In the practice of an embodiment of the methods, the loading surface is a belted conveyor that transports items loaded on the belt to a position adjacent the scanner when activated. A cashier in a cashier station adjacent the scanner scans the items and places the items directly into one or more bags supported on one or more of the bag holders on the carousel, wherein the carousel is rotated when necessary to utilize more than one bag, or to unload filled bags, and wherein the cashier places items too large or bulky to be contained in a bag on the planar surface above the carousel; and monitoring the pay station to be ensured that the customer makes the proper payment. The cashier or customer can then remove the loaded bags by rotating the carousel and as a rack with an empty bag rotates to the cashier, the next customer's transaction can be started while the previous customer is still loading bags from the carousel.

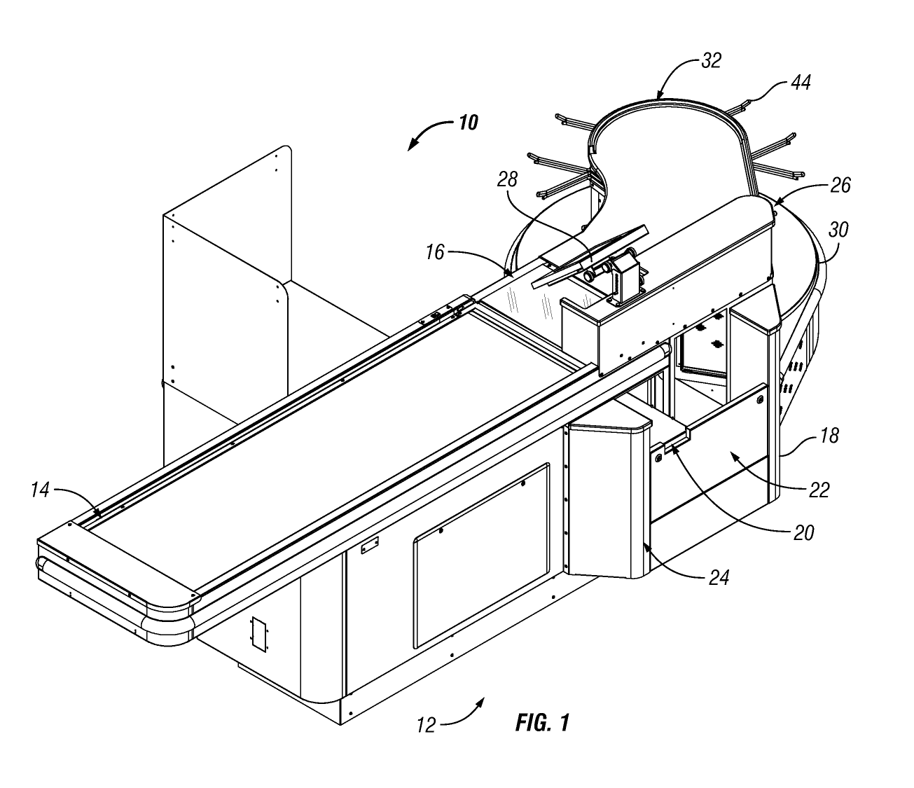

An embodiment of a checkstand 10 of the disclosure is shown in FIG. 1 in a perspective view from the customer's side 12 of the checkstand. In a retail store, a customer approaches the checkstand from the customer side in the direction of the arrow 12, possibly with a shopping cart of items to purchase. The items are loaded onto the belt of conveyor 14, which when activated moves the items to a position adjacent the scanner 16. Opposite the scanner is a self service pay station 18 that provides a location for a coin acceptor 20 and a bill acceptor 22. A cart deflector 24 protects the pay station from damage.

As shown in the drawing, the checkstand can further include a check shelf 26 for the customer's convenience. The check shelf also provides support for a monitor 28, which allows the cashier to monitor the listing of items and the customer's payment.

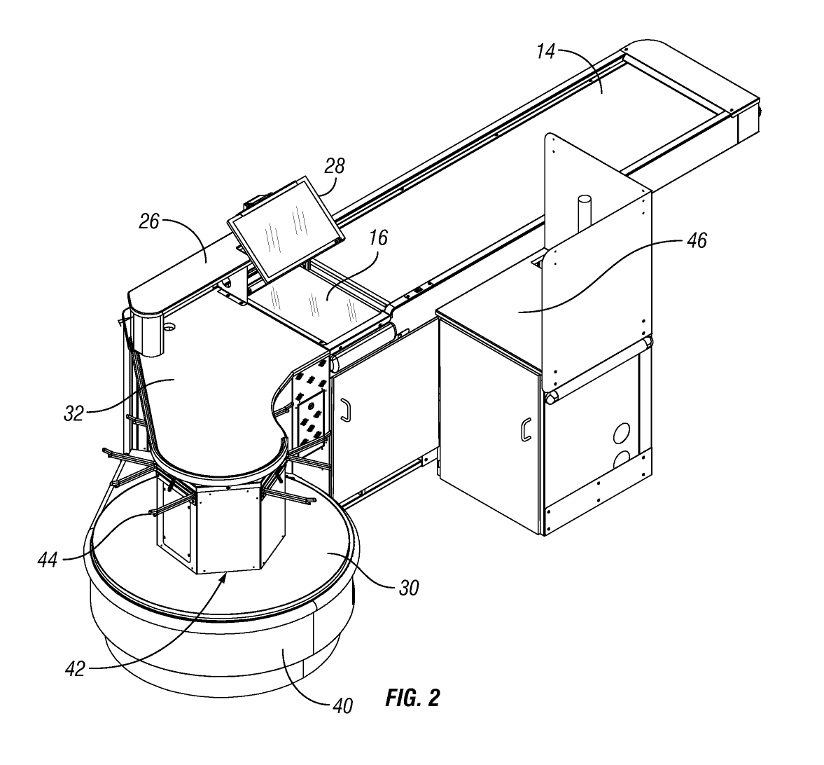

The baggage carousel 30 is opposite the scanner from the conveyor and is at least partly covered by a deck 32, also termed a set-aside deck in that items too large or bulky for the bags can be set on this deck for retrieval by a customer. The bagging carousel can be seen better in FIG. 2. In the embodiment shown in FIG. 2, the bagging station includes a carousel with a stationary base 40 and a rotatable carousel 30 which includes a dodecagonal central column or axis 42 with six bag racks 44 attached, one to every other face. It can be seen from this drawing that the set aside deck is on substantially the same plane as the conveyor and scanner so the cashier does not have to lift heavy or bulky items. Adjacent the scanner is the cashier station 46 where a cashier can stand or sit. The cashier station includes a cabinet and/or drawers 48, any of which can be lockable for storage of restricted items and other supplies.

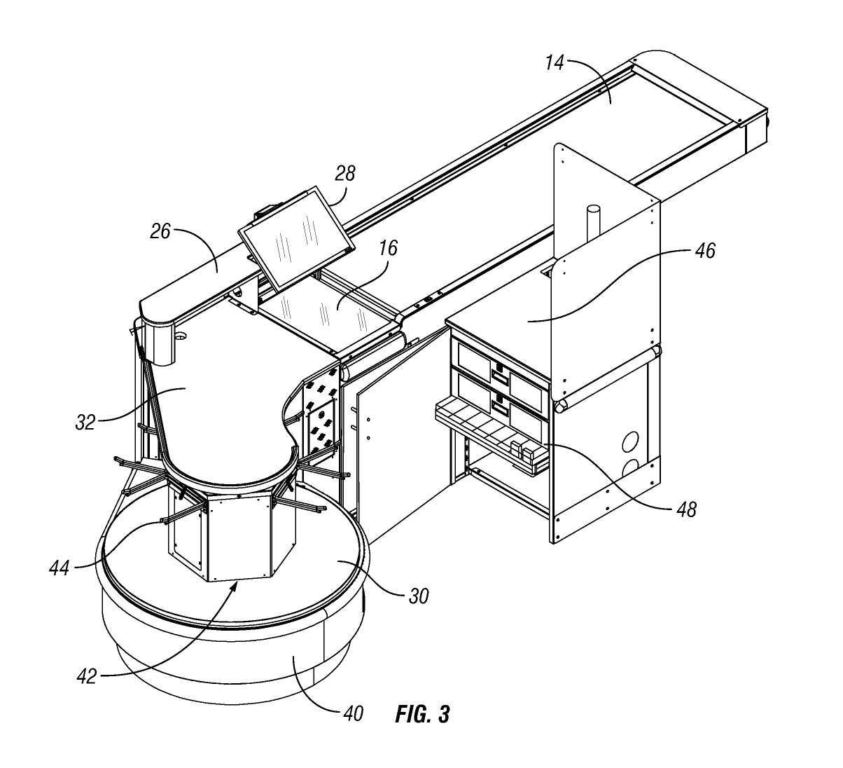

An embodiment including a lockable cabinet is shown with a cabinet door open in FIG. 3. In this embodiment, drawers for secure items and racks for cigarettes for example can be provided. Another feature of the checkstand, an inset shelf or storage area 48 can be provided in the base 40 of the carousel.

While particular embodiments of the invention and method steps of the invention have been described herein in terms of preferred embodiments, additional alternatives not specifically disclosed but known in the art are intended to fall within the scope of the disclosure. Thus, it will be apparent to those of skill in the art that variations may be applied to the devices and/or methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

1. A checkstand for use in a retail store, the checkstand comprising:
a belted conveyor providing a surface for loading of items onto the checkstand;
a scanner adjacent an end of the conveyor; and
a carousel bagging device adjacent the scanner and on the opposite side of the scanner from the conveyor; the bagging device comprising a plurality of bag holders spaced around a turnable central column and a horizontal, planar surface at least partially above the carousel and sized to support items too large to fit in conventional bags.

2. The checkstand of claim 1, comprising a self service pay station disposed on a side of the checkstand to be accessible by a customer.

3. The checkstand of claim 1, wherein the central column forms an even sided polygonal shape and the bag holders are attached to every other face of the column.

4. The checkstand of claim 1, wherein the carousel comprises a dodecagonal shape with six attached bag holders.

5. The checkstand of claim 1, wherein the pay station comprises a coin acceptor, a bill acceptor, a credit card reader or a combination thereof.

6. The checkstand of claim 1, wherein the planar surface is attached to the checkstand adjacent the scanner and forms a continuous planar surface extending over the central axis.

7. The checkstand of claim 1, further comprising a cashier station adjacent the scanner, wherein the cashier station comprises a lockable cabinet or drawer.

8. A checkstand for a retail checkout comprising a bagging station, the bagging station comprising:
a stationary cylindrically shaped base; and
a carousel attached on top of the base by a central axis, the carousel comprising a rotatable platform and a central rotatable column wherein a plurality of bag holders are attached to and spaced around the central column;
and wherein the checkstand further comprises a planar surface disposed at least partially above the carousel and sized to hold items too large for conventional bags.

9. The checkstand of claim 8, wherein the base comprises one or more shelves below the level of the carousel.

10. The checkstand of claim 8, wherein the central column is a 12 sided column.

11. The checkstand of claim 10, wherein the carousel comprises 6 bag holders each attached to a side of the central column.

12. The checkstand of claim 8, wherein the central column is an 8 sided column.

13. The checkstand of claim 12, wherein the carousel comprises 4 bag holders each attached to a side of the central column.

14. The checkstand of claim 8, wherein the central column is a 6 sided column.

15. The checkstand of claim 14, wherein the carousel comprises 3 bag holders each attached to a side of the central column.

16. An improved method of retail checking comprising:
providing a checkstand comprising
(a) a conveyor providing a surface for loading of items accessible from at least a first side of the checkstand;
(b) a cashier station disposed at an end of the conveyor on a second side of the checkstand opposite the first side, and comprising a scanner; and
(c) a carousel bagging device adjacent the scanner and comprising a plurality of bag holders spaced around a turnable central column and a horizontal, planar surface above the carousel and sized to support items too large to fit in conventional bags;
activating the conveyor effective to move items placed on the conveyor toward the cashier station; and
providing a cashier in the cashier station who scans the items and places the items directly into one or more bags supported on one or more of the bag holders, wherein the carousel is rotated when necessary to utilize more than one bag, and wherein the cashier places items too large or bulky to be contained in a bag on the planar surface above the carousel.

17. The method of claim 16, wherein the checkstand comprises a pay station on the first side of the checkstand and the method comprises providing the pay station in a customer accessible location and accepting payment from the customer directly into a pay receiving apparatus.
